(19) United States
(12) Patent Application Publication
(10) Pub. No.: US 2026/0056487 A1
(43) Pub. Date: Feb. 26, 2026

(54) DEVELOPING APPARATUS AND IMAGE FORMING APPARATUS

(71) Applicant: FUJIFILM Business Innovation Corp., Tokyo (JP)

(72) Inventors: Shunsuke YAMASAKI, Kanagawa (JP); Kazunari ISHII, Kanagawa (JP); Yasuhisa GONDA, Kanagawa (JP); Yuta SHIMATATE, Kanagawa (JP); Chihiro TONE, Kanagawa (JP)

(73) Assignee: FUJIFILM Business Innovation Corp., Tokyo (JP)

(21) Appl. No.: 19/056,696

(22) Filed: Feb. 18, 2025

(30) Foreign Application Priority Data
Aug. 23, 2024 (JP) 2024-143483

(51) Int. Cl. G03G 15/08; G03G 21/20

(52) U.S. Cl. CPC G03G 15/0844; G03G 21/206

(57) ABSTRACT

A developing apparatus includes a developing roll that holds developer and is rotated; an image holder that is disposed to face the developing roll and is rotated; and a suction duct that is provided with a suction port formed to correspond to at least both end portions of the developing roll, sucks the developer from an image holder side via the suction port, and has a developer separation structure that is disposed adjacent to the suction port and separates the developer from an airflow by changing a direction of the airflow in the suction duct.

### CROSS-REFERENCE TO RELATED APPLICATIONS

This application is based on and claims priority under 35 USC 119 from Japanese Patent Application No. 2024-143483 filed Aug. 23, 2024.

### BACKGROUND

### (i) Technical Field

The present invention relates to a developing apparatus and an image forming apparatus.

### (ii) Related Art

The electrophotographic image forming apparatus has a developing apparatus including an image holder and a developer supply device that supplies developer to the image holder. The developing apparatus includes a developing roll that holds the developer on a surface thereof. The developer held on the developing roll is migrated to the image holder, and an electrostatic latent image on the image holder is developed. A part of the developer that is not used for development floats near the developing roll and the image holder. The floating developer is sucked with an airflow and recovered. A filter is provided to prevent the developer from being discharged to the outside of the image forming apparatus. A technique for recovering the floating developer is disclosed in JP2005-242195A and JP1999-161119A.

In JP2005-242195A, the developer (toner) sent through a transport duct (29) and a suction duct (31) is stuck and recovered by a magnetic body (35). The developer is stuck to the magnetic body (35) on an upstream side of the filter (33). In JP1999-161119A, the developer (toner) is deposited in a duct (4) disposed along a photosensitive drum (1). The deposited developer is sent by a screw (6), and is recovered in a toner recovery box (9) positioned on the upstream side of the filter (10). Note that the reference numerals in parentheses are reference numerals used in JP2005-242195A and JP1999-161119A, and are not related to the reference numerals used in the description of exemplary embodiments of the present application.

### SUMMARY

In recent years, there has been a demand for an increase in speed of an image forming apparatus, and the amount of developer recovered together with an airflow is increased with the increase in speed. The increase in the amount of the recovered developer accelerates the clogging of a filter and a flow path leading to the filter which are for preventing the developer from being discharged to the outside of the image forming apparatus.

Aspects of non-limiting embodiments of the present disclosure relate to a developing apparatus and an image forming apparatus that suppress clogging of a filter by developer or deposition of developer on a flow path leading to a filter.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing apparatus including a developing roll that holds developer and is rotated; an image holder that is disposed to face the developing roll and is rotated; and a suction duct that is provided with a suction port formed to correspond to at least both end portions of the developing roll, sucks the developer from an image holder side via the suction port, and has a developer separation structure that is disposed adjacent to the suction port and separates the developer from an airflow by changing a direction of the airflow in the suction duct.

### BRIEF DESCRIPTION OF THE DRAWINGS

Exemplary embodiment(s) of the present invention will be described in detail based on the following figures, wherein:

FIG. 1 is a diagram illustrating a schematic configuration of an image forming apparatus;

FIG. 2 is a perspective view illustrating an appearance of a developer supply device of a developing apparatus of the present exemplary embodiment;

FIG. 3 is a schematic diagram illustrating a cross section of the developing apparatus of the present exemplary embodiment;

FIG. 4 is a diagram schematically illustrating a configuration of a developer discharge device;

FIG. 5 is a diagram schematically illustrating another configuration example of a suction duct; and

FIG. 6 is a diagram schematically illustrating still another configuration example of the suction duct.

### DETAILED DESCRIPTION

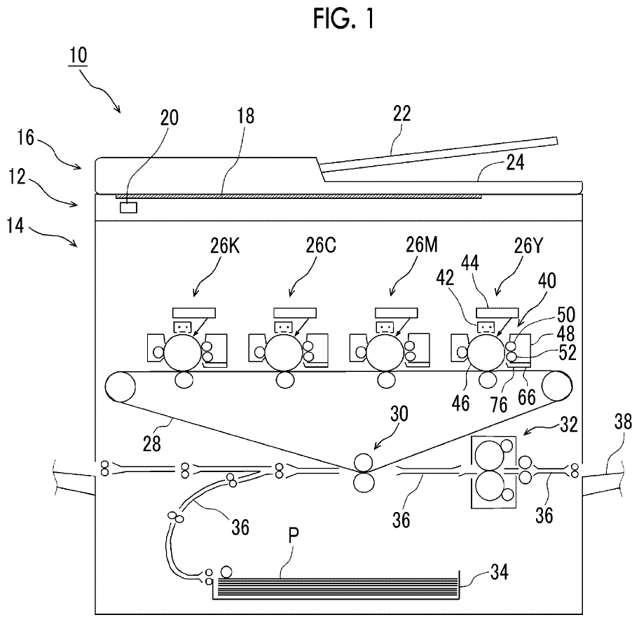

FIG. 1 is a diagram illustrating a schematic configuration of an image forming apparatus 10. The image forming apparatus 10 includes an image reading unit 12, an image forming section 14, and a document transport unit 16. The image reading unit 12 is a unit that optically reads an image of a document. The document is placed on a platen glass 18, and an image on the document is optically read by an image reading element 20 configured by a CCD or the like. The image of the entire document is read by moving the image reading element 20 along the platen glass 18. In addition, the document may be transported by the document transport unit 16, and the image on the document may be read by the image reading element 20 during the transport process. The document is transported one by one from a document feeding tray 22 of the document transport unit 16 to a document discharge tray 24, and is read during the process. In this case, the image of the entire document is read while the image reading element 20 remains stationary.

The image forming section 14 forms an image on a paper sheet P on the basis of image information read by the image reading unit 12 or image information sent from an external device such as a personal computer. The image forming section 14 is an electrophotographic device that forms a color image on the paper sheet P using four-color developer. The image forming section 14 includes image forming units 26Y, 26M, 26C, and 26K that respectively form developer images in each color of yellow (Y), magenta (M), cyan (C), and black (K). The image forming units 26Y, 26M, 26C, and 26K have no differences other than the color to form, and are referred to collectively as the image forming unit 26 by omitting Y, M, C, and K in a case where there is no need to distinguish between colors. The image forming section 14 includes an intermediate transfer belt 28 on which the developer image formed by the image forming unit 26 of each color is transferred, a transfer unit 30 that transfers the developer image on the intermediate transfer belt 28 to the paper sheet P, and a fixing unit 32 that fixes the transferred developer image on the paper sheet P. Furthermore, the image forming section 14 includes a paper sheet container 34 that accommodates the paper sheet P, and a paper sheet transport device 36 that transports the paper sheet P one by one from the paper sheet container 34, allowing the paper sheet P to sequentially pass through the transfer unit 30 and the fixing unit 32.

The developer image of each color formed by the image forming unit 26 is transferred and superimposed on the intermediate transfer belt 28. The developer image on the intermediate transfer belt 28 is sent to the transfer unit 30 along with the circulation of the intermediate transfer belt 28, and is transferred to the paper sheet P transported by the paper sheet transport device 36. The paper sheet P is further transported to the fixing unit 32 by the paper sheet transport device 36 to be heated and pressurized here, and the developer image is fixed on the paper sheet P. The paper sheet P on which the image is formed is sent to a paper discharge tray 38 by the paper sheet transport device 36.

As typically illustrated in the yellow image forming unit 26Y, the image forming unit 26 includes a developing apparatus 40, a charger 42, and an exposure device 44. The developing apparatus 40 includes an image holder 46 and a developer supply device 48 that supplies developer to the image holder 46. The charger 42 charges the surface of the image holder 46. The exposure device 44 irradiates the surface of the charged image holder 46 with light such as laser light to form an electrostatic latent image on the surface of the image holder 46. The exposure device 44 controls the light to be emitted, on the basis of the image information acquired from the image reading unit 12 or the external device to form the electrostatic latent image. The developer is supplied from the developer supply device 48 to the image holder 46 on which the electrostatic latent image is formed, and the latent image is developed.

The image forming apparatus 10 includes four image forming units 26 corresponding to four colors of the developer. The number of image forming units corresponds to the number of colors of the developer. In a case where the developer is one color, the number of image forming units is one. In the image forming apparatus 10, the developer image formed by the image forming unit 26 is indirectly transferred to the paper sheet P via the intermediate transfer belt 28. Instead of this, the developer image may be directly transferred from the image forming unit to the paper sheet.

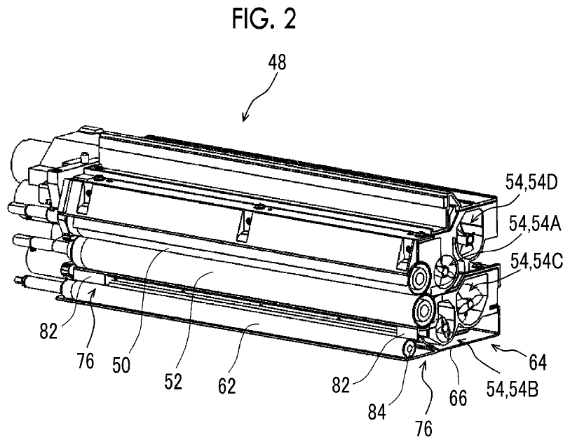

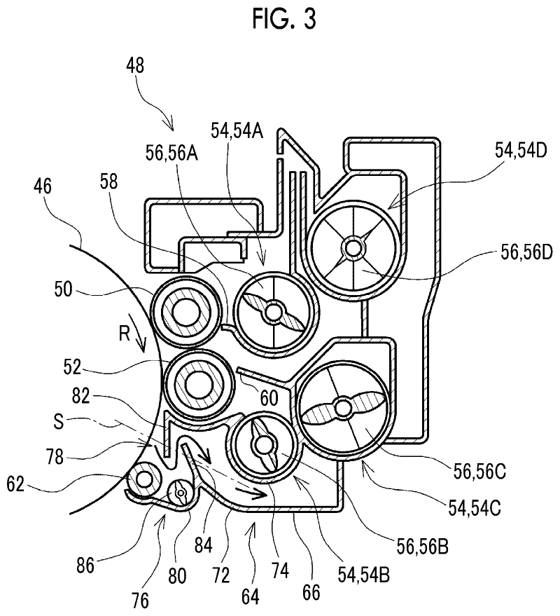

FIGS. 2 and 3 are diagrams illustrating the schematic configuration of the developing apparatus 40 provided in the image forming unit 26 of the image forming apparatus 10. FIG. 2 is a perspective view illustrating a configuration of a main part of the developer supply device 48 of the developing apparatus 40, and FIG. 3 is a cross-sectional view of the developer supply device 48 and an image holder 46. An up-down direction in FIGS. 2 and 3 corresponds to a direction of gravity in a case where the developing apparatus 40 is installed in the image forming apparatus 10.

The developing apparatus 40 is disposed in the image forming apparatus 10 in a state where the image holder 46 and the developer supply device 48 face each other. In the image holder 46, the electrostatic latent image is formed on the surface, and the electrostatic latent image is developed by the developer supplied from the developer supply device 48. The developer image formed on the surface of the image holder 46 by the development is transferred onto a recording medium such as a paper sheet or an intermediate transfer belt 28. The developer image transferred to the intermediate transfer belt 28 is transferred to the recording medium later. The developer may be a toner. The image holder 46 is, for example, a photosensitive roll having a cylindrical shape, and is rotated around a center line of the cylinder. A rotation direction of the image holder 46 is indicated by an arrow R in FIG. 3. By this rotation, the developer image is sequentially formed on the image holder 46 at a position facing the developer supply device 48, and the developer image is further sent to a position where the developer image is transferred to the recording medium.

The developer supply device 48 includes developing rolls 50 and 52 that hold the developer to be supplied to the image holder 46. The developer supply device 48 includes two developing rolls 50 and 52, but the number of developing rolls may be, for example, one other than two. The developing rolls 50 and 52 are disposed to face the image holder 46. Each of the developing rolls 50 and 52 has a cylindrical shape, and center lines thereof are disposed along a direction in which a center line of the image holder 46 having the cylindrical shape extends. In addition, the developing rolls 50 and 52 are disposed close to each other by forming a gap between the developing rolls 50 and 52 and the image holder 46. Hereinafter, a region sandwiched between the developing rolls 50 and 52 and the image holder 46 is referred to as a “nip”. The developing rolls 50 and 52 are rotated around the center line. The direction of the rotation is a direction in which the directions of the movement of the surfaces of the developing rolls 50 and 52 and the image holder 46 are aligned at a portion facing the image holder 46. The directions of the rotation of the image holder 46 and the developing rolls 50 and 52 may be opposite to each other. In a portion where the developing rolls 50 and 52 and the image holder 46 face each other, a direction in which the surface is moved with the rotation is described as a “direction of rotational movement” below, and a direction intersecting the direction of rotational movement is described as an “intersection direction” below. The intersection direction is also a direction in which the center lines of the developing rolls 50 and 52 extend.

The developing rolls 50 and 52 stick and hold the developer on the surfaces thereof by magnetic force. The developer is supplied to the nip along with the rotation of the developing rolls 50 and 52, and the electrostatic latent image on the image holder 46 is developed.

The developer supply device 48 has a developer transport path 54 that supplies the developer to the developing rolls 50 and 52 and recovers the developer from the developing rolls 50 and 52. The developer transport path 54 includes four linear developer transport paths 54A, 54B, 54C, and 54D. Note that the number of the developer transport paths 54 is not limited to four. Each of the four linear developer transport paths 54 extends along the intersection direction. Each developer transport path 54 includes a transport screw 56 having a helical blade. The transport screws 56 are associated with the four developer transport paths 54A, 54B, 54C, and 54D to which the transport screws 56 respectively belong, and are referred to as transport screws 56A, 56B, 56C, and 56D, respectively. The transport screw 56 is rotated, and thus the helical blade stirs the developer and sends the developer along a direction in which the developer transport path 54 extends. The developer is charged by stirring. The developer transport path 54 further includes a conveyance transport path (not illustrated) that conveys the developer between the linear developer transport paths 54A to 54D.

The developer transport path 54A is a transport path for supplying the developer to the developing rolls 50 and 52, and is hereinafter referred to as a supply developer transport path 54A. In the supply developer transport path 54A, the developer is transported along the intersection direction, and is supplied to the developing roll 50 positioned above. The developer is further sent from the developing roll 50 to the developing roll 52 positioned below the developing roll 50. The developer transport path 54B is a transport path for transporting the developer recovered from the developing rolls 50 and 52, and is hereinafter referred to as a recovery developer transport path 54B. The developer transport paths 54C and 54D are transport paths that send the developer conveyed from the recovery developer transport path 54B toward the supply developer transport path 54A, and are hereinafter referred to as a first intermediate developer transport path 54C and a second intermediate developer transport path 54D, respectively.

The developer is sent to circulate through the supply developer transport path 54A and the second intermediate developer transport path 54D. The developer sent to an end portion of the supply developer transport path 54A is conveyed to the second intermediate developer transport path 54D, and from there, the developer is sent to the opposite end portion of the second intermediate developer transport path 54D in a reverse direction. The developer sent to an end portion of the second intermediate developer transport path 54D is conveyed to the supply developer transport path 54A. The developer is supplied over the entire length of the developing roll 50 in the process of being sent along the supply developer transport path 54A. The developer received in the recovery developer transport path 54B is sent to an end portion of the recovery developer transport path 54B, and is conveyed to the first intermediate developer transport path 54C from the end portion. The developer is sent toward the other end portion along the first intermediate developer transport path 54C, and is conveyed from the other end portion to the second intermediate developer transport path 54D.

The conveyance of the developer from the developer transport path 54 disposed below to the developer transport path 54 disposed above can be performed using magnetic force of a permanent magnet. For example, the conveyance of the developer from the supply developer transport path 54A to the second intermediate developer transport path 54D is performed using a columnar body having a permanent magnet provided at an end portion of the transport screw 56A and integrated with the transport screw 56A in a coaxial manner. The columnar body is rotated integrally with the transport screw 56A. The developer stuck to the permanent magnet is pumped up to the second intermediate developer transport path 54D at a high position by the rotation of the columnar body. The developer stuck to the permanent magnet is scraped off and put into the second intermediate developer transport path 54D.

The developer held on the developing rolls 50 and 52 is scraped off to remove the excess such that the thickness thereof becomes a predetermined value. The developer brush remaining on the surface of the developing rolls 50 and 52 after passing through the nip is moved along with the rotation of the developing rolls 50 and 52. During the process of the movement, some of the developer brush collides with the surrounding structures (for example, portions indicated by reference numerals 58 and 60 in FIG. 3) of the developing rolls 50 and 52. The developer scatters due to the impact at this time. In addition, even in a case where the developer falls into the recovery developer transport path 54B, the developer scatters due to the impact of the fall. The scattered developer floats in a region around the nip. In order to suppress the diffusion of the floating developer, a sealing roll 62 is provided on the downstream side of the developing roll 52 in a direction R of the rotational movement of the image holder 46. The sealing roll 62 extends along the image holder 46, and is in contact with the surface of the image holder 46. A developer discharge device 64 is provided in order to recover the floating developer.

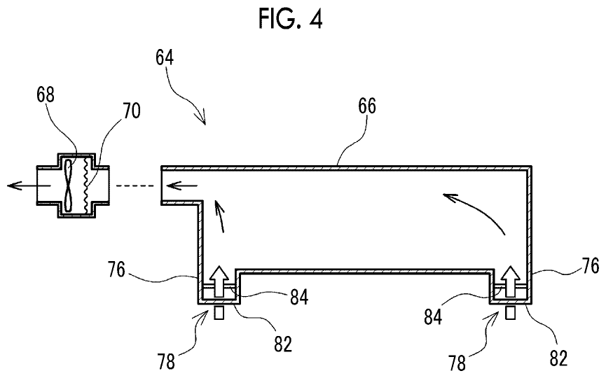

FIG. 4 is a diagram schematically illustrating a configuration of the developer discharge device 64. The developer discharge device 64 includes a suction duct 66 that is provided integrally with the developer supply device 48, and a suction fan 68 that is connected to the suction duct 66 via a pipe. The suction duct 66 is disposed on the downstream side of the nip in the direction R of the rotational movement of the image holder 46 and the developing roll 52. Air in a region around the nip is sucked by the suction fan 68 via the suction duct 66. The developer contained in the sucked airflow is collected in a filter 70 disposed on the upstream side of the suction fan 68.

As illustrated in FIG. 3, the suction duct 66 may be formed of a part of a component that defines the developer transport path 54 and a lower cover 72 that faces a part of the component. The sucked air flows through a region sandwiched between a lower portion of the component that defines the recovery developer transport path 54B and the first intermediate developer transport path 54C (in FIG. 3, a portion indicated by reference numeral 74) and the lower cover 72.

The suction duct 66 has protruding portions 76 that have a duct shape and protrude toward the nip at both end portions in the intersection direction. The protruding portions 76 are provided to correspond to both end portions of the developing rolls 50 and 52. In addition to both the end portions of the developing rolls 50 and 52, the protruding portion 76 may be provided to correspond to a portion between the end portions. A suction port 78 that sucks air together with the developer from the nip and a peripheral region of the nip is formed in the protruding portion 76. A direction from the nip peripheral region toward the back of the suction duct 66 is referred to as a developer suction direction S. In addition, the protruding portion 76 has a developer receiver 80 that receives the developer sucked to the lower portion.

The protruding portion 76 is provided with a developer separation structure that changes the direction of the airflow sucked in adjacent to the suction port 78 and thereby separates the developer from the airflow. The developer separation structure may be disposed in the protruding portion 76. The developer separation structure has two plate-shaped walls 82 and 84 provided to intersect the developer suction direction S. The walls 82 and 84 are provided over the entire width of the duct-shaped protruding portion 76. The wall hanging down from an upper surface of the protruding portion 76 is referred to as a hanging wall 82, and the wall standing up from a lower surface of the protruding portion 76 is referred to as a standing wall 84. The hanging wall 82 is positioned at a distal end of the protruding portion 76, that is, at an end portion on the nip peripheral region side, and the standing wall 84 is positioned farther from the nip peripheral region than the hanging wall 82, that is, positioned at the inner side of the protruding portion 76. The hanging wall 82 and the standing wall 84 are disposed to partially overlap each other in a case of being viewed along the developer suction direction S. As a result, the direction of the airflow passing through the protruding portion 76 is sequentially changed from downward, upward, and downward. In a region where the deflected direction of the airflow is changed, particularly in a region where the direction is changed from downward to upward, the developer is separated. The separated developer is received in the developer receiver 80 at a bottom portion of the protruding portion 76, and is deposited here. The developer receiver 80 may be disposed on an extension line of a portion of the protruding portion 76 that guides the airflow downward. More hanging walls and standing walls may be alternately disposed.

A transport mechanism that transports the developer, particularly a discharge screw 86, may be provided in order to discharge the developer deposited in the developer receiver 80. The discharge screw 86 has a helical blade, and the helical blade is rotated to send the developer along a rotation axis direction, and discharges the developer from the developer receiver 80. The discharge screw 86 discharges the developer periodically or irregularly. In addition, instead of the discharge of the developer by the discharge screw 86, the developer receiver 80 may be attachable and detachable to and from the suction duct 66, particularly, to and from the lower cover 72 of the suction duct. In a case of maintenance of the image forming apparatus 10, the operator may detach the developer receiver 80 to remove the deposited developer.

The developer supply device 48 has the suction duct 66 for discharging the floating developer from the nip and the peripheral region of the nip. In the protruding portion 76 of the suction duct 66, the direction of the airflow is changed to separate the developer from the airflow. As a result, the amount of the developer reaching the filter 70 is reduced, and clogging of the filter 70 is suppressed, as compared with a case where the developer is not separated. In the maintenance work of the image forming apparatus 10, the frequency of cleaning or replacing the filter 70 is reduced. In addition, by separating the sucked developer from the airflow at an early stage, the developer deposited in the flow path leading to the suction duct 66 and the filter 70 on the downstream side of the protruding portion 76 is also reduced. Accordingly, the frequency of replacement of the developing apparatus due to the clogging of the flow path in the suction duct 66 is reduced.

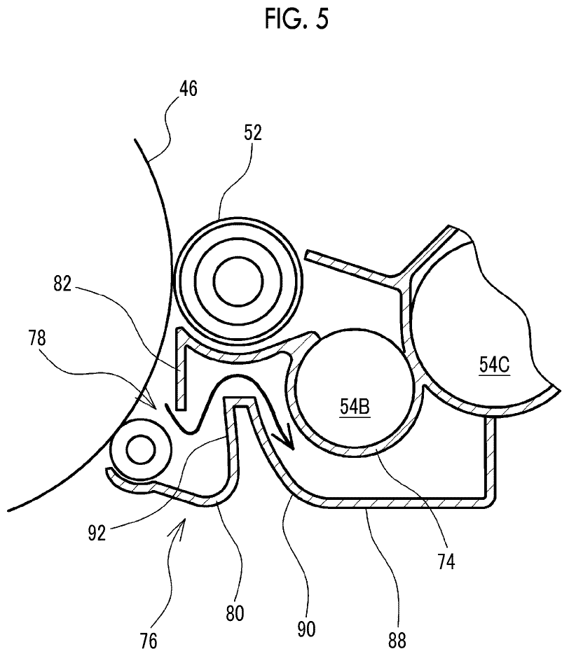

FIG. 5 is a diagram illustrating another aspect of the suction duct. In the above-described suction duct 66, the standing wall 84 is formed by a plate-shaped member standing up from the lower surface of the lower cover 72. On the other hand, in a suction duct 88 illustrated in FIG. 5, a part of a lower cover 90 that separates the inside and outside of the suction duct 88 defines a standing wall 92. The developer receiver 80 and the lower cover 90 following the developer receiver 80 form a step, and a portion corresponding to a riser in the case of a staircase serves as the standing wall 92.

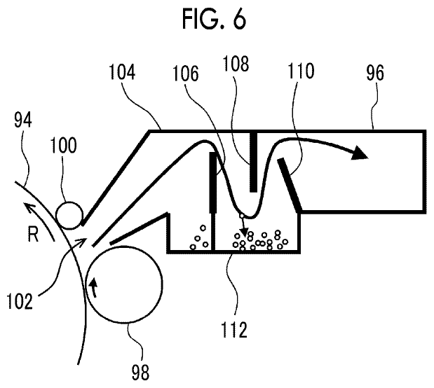

FIG. 6 is a diagram illustrating a configuration of a suction duct 96 corresponding to an image holder 94 of which the movement direction of the surface is upward. The suction duct 96 has a protruding portion 104 having a suction port 102 between a developing roll 98 and a sealing roll 100. In the protruding portion 104, a first standing wall 106, a hanging wall 108, and a second standing wall 110 are arranged along the developer suction direction, and a developer receiver 112 is provided at a lower portion. The airflow flows by being deflected up and down by the first standing wall 106, the hanging wall 108, and the second standing wall 110. The developer is separated in a portion where the airflow is deflected, particularly in a portion where the direction of the airflow is changed from downward to upward. The separated developer is received and deposited in the developer receiver 112. In order to remove the deposited developer, the developer receiver 112 may be attachable and detachable, or a discharge mechanism such as a screw having a helical blade may be provided.

### Supplementary Notes

1

A developing apparatus comprising:
a developing roll that holds developer and is rotated;
an image holder that is disposed to face the developing roll and is rotated; and
a suction duct that is provided with a suction port formed to correspond to at least both end portions of the developing roll, sucks the developer from an image holder side via the suction port, and has a developer separation structure that is disposed adjacent to the suction port and separates the developer from an airflow by changing a direction of the airflow in the suction duct.
   2

### The Developing Apparatus According to (((1))),

wherein the developer separation structure includes a hanging wall that hangs down from an upper surface of the suction duct and is disposed to intersect a suction direction of the developer, and a standing wall that stands up from a lower surface of the suction duct and is disposed to intersect the suction direction of the developer, and
the hanging wall and the standing wall are arranged along the suction direction of the developer, and disposed to partially overlap each other in a case of being viewed from the suction direction of the developer.
   3

The developing apparatus according to (((2))),
wherein the suction duct has a developer receiver that receives the separated developer, below the hanging wall.
   4

The developing apparatus according to (((3))),
wherein the developer receiver is attachable and detachable to and from a main body of the suction duct.
   5

The developing apparatus according to (((3))), further comprising:
a transport mechanism that transports the developer deposited in the developer receiver, and discharges the developer from the suction duct.
   6

The developing apparatus according to (((2))),
wherein in the hanging wall and the standing wall that are arranged, the hanging wall is disposed on a most upstream side in the suction direction of the developer.
   7

The developing apparatus according to (((1))),
wherein the developer separation structure includes a bent flow path that deflects the airflow up and down in the suction duct.
   8

The developing apparatus according to (((7))), further comprising:
a developer receiver that receives the separated developer, on an extension line of a portion of the bent flow path, the portion guiding the airflow downward.
   9

The developing apparatus according to (((8))),
wherein the developer receiver is attachable and detachable to and from a main body of the suction duct.
   10

The developing apparatus according to (((8))), further comprising:
a transport mechanism that transports the developer deposited in the developer receiver, and discharges the developer from the suction duct.
   11

The developing apparatus according to (((7))),
wherein the bent flow path is a flow path in which the airflow on a most upstream side in the suction direction of the developer flows downward.
   12

An image forming apparatus comprising:
the developing apparatus according to any one of (((1))) to (((11)));
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing apparatus comprising:
a developing roll that holds developer and is rotated;
an image holder that is disposed to face the developing roll and is rotated; and
a suction duct that is provided with a suction port formed to correspond to at least both end portions of the developing roll, sucks the developer from an image holder side via the suction port, and has a developer separation structure that is disposed adjacent to the suction port and separates the developer from an airflow by changing a direction of the airflow in the suction duct.

2. The developing apparatus according to claim 1,
wherein the developer separation structure includes a hanging wall that hangs down from an upper surface of the suction duct and is disposed to intersect a suction direction of the developer, and a standing wall that stands up from a lower surface of the suction duct and is disposed to intersect the suction direction of the developer, and
the hanging wall and the standing wall are arranged along the suction direction of the developer, and disposed to partially overlap each other in a case of being viewed from the suction direction of the developer.

3. The developing apparatus according to claim 2,
wherein the suction duct has a developer receiver that receives the separated developer, below the hanging wall.

4. The developing apparatus according to claim 3,
wherein the developer receiver is attachable and detachable to and from a main body of the suction duct.

5. The developing apparatus according to claim 3, further comprising:
a transport mechanism that transports the developer deposited in the developer receiver, and discharges the developer from the suction duct.

6. The developing apparatus according to claim 2,
wherein in the hanging wall and the standing wall that are arranged, the hanging wall is disposed on a most upstream side in the suction direction of the developer.

7. The developing apparatus according to claim 1,
wherein the developer separation structure includes a bent flow path that deflects the airflow up and down in the suction duct.

8. The developing apparatus according to claim 7, further comprising:
a developer receiver that receives the separated developer, on an extension line of a portion of the bent flow path, the portion guiding the airflow downward.

9. The developing apparatus according to claim 8,
wherein the developer receiver is attachable and detachable to and from a main body of the suction duct.

10. The developing apparatus according to claim 8, further comprising:
a transport mechanism that transports the developer deposited in the developer receiver, and discharges the developer from the suction duct.

11. The developing apparatus according to claim 7,
wherein the bent flow path is a flow path in which the airflow on a most upstream side in the suction direction of the developer flows downward.

12. An image forming apparatus comprising:
the developing apparatus according to claim 1;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

13. An image forming apparatus comprising:
the developing apparatus according to claim 2;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

14. An image forming apparatus comprising:
the developing apparatus according to claim 3;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

15. An image forming apparatus comprising:
the developing apparatus according to claim 4;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

16. An image forming apparatus comprising:
the developing apparatus according to claim 5;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

17. An image forming apparatus comprising:
the developing apparatus according to claim 6;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

18. An image forming apparatus comprising:
the developing apparatus according to claim 7;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

19. An image forming apparatus comprising:
the developing apparatus according to claim 8;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.

20. An image forming apparatus comprising:
the developing apparatus according to claim 9;
a charger that charges a surface of the image holder;
an exposure device that exposes the charged image holder with light, and forms an electrostatic latent image on the image holder;
a transfer unit that transfers a developer image obtained by the electrostatic latent image being developed by the developer supplied from the developing roll, directly or indirectly to a paper sheet from the developing roll;
a fixing unit that fixes the developer image transferred on the paper sheet, to the paper sheet; and
a transport device that transports the paper sheet such that the paper sheet passes through the transfer unit and the fixing unit.
